(19) United States
(12) Patent Application Publication
(10) Pub. No.: US 2020/0011203 A1
(43) Pub. Date: Jan. 9, 2020

(54) BLADE CONTAINMENT STRUCTURE

(71) Applicant: General Electric Company, Schenectady, NY (US)

(72) Inventors: Nagamohan Govinahalli Prabhakar, Bangalore (IN); Manoj Kumar Jain, Bangalore (IN); Nitesh Jain, Bangalore (IN); Uma Maheshwar Domala, Bangalore (IN); Nicholas Joseph Kray, Mason, OH (US)

(21) Appl. No.: 16/028,867

(22) Filed: Jul. 6, 2018

(51) Int. Cl. F01D 25/24; F01D 25/00

(52) U.S. Cl. CPC F01D 25/24; F01D 25/005; F05D 2210/12; F05D 2220/323; F05D 2230/40; F05D 2300/133; F05D 2240/14; F05D 2260/00; F05D 2300/30; F05D 2300/121; F05D 2230/50

(57) ABSTRACT

A blade containment structure surrounding a fan in a turbofan engine is disclosed. The blade containment structure includes a cellular material to absorb energy and contain fragments of a blade thrown outward; an inner shell; a ductile back sheet spaced radially outward from the inner shell, the ductile back sheet and inner shell cooperating to define a nesting area for the cellular material, wherein the cellular material is bound at its radially inner surface by the inner shell and at its outer surface by the ductile back sheet; and a containment blanket overlaid on the ductile back sheet, the containment blanket being of the type effective to contain fragments of the blade that penetrate through the ductile back sheet.

### BACKGROUND OF THE INVENTION

This invention relates generally to a containment structure which surrounds a turbomachinery rotor. More particularly, the invention relates to a fan blade containment structure including means for retaining structural strength in the sealing area of a fan of a turbofan aircraft engine after damage.

The fan includes a rotor with large, heavy rotating blades and is positioned at a forward end of a turbofan engine to force ambient air into flow passages to provide thrust. Since the fan is located at the forward end of the turbofan engine, it is the rotating element most at risk of damage or catastrophic failure, for example by ingestion of foreign object debris (“FOD”) such as, for example, a bird strike. A bird strike may damage the fan and, in an extreme case, may dislodge one or more fragments or entire blades of the fan.

For practical and regulatory reasons, a containment structure must be provided which prevents damaged fan blades or fragments thereof from exiting the engine nacelle and damaging other parts of the aircraft or injuring occupants.

In some circumstances there is a “fly back home” requirement; i.e. the turbofan engine would be required to continue functioning after a blade-out event, or at least not be so damaged that the aircraft could not be flown for the remainder of the flight. This is a structural challenge because when one blade is lost, there is a massive imbalance of the large and heavy fan rotor.

Various types of containment are old and well-known and typically include an annular band of material surrounding the tips of the fan blades for intercepting fragments before they can pass out of the engine and cause further damage to the aircraft or surrounding area. One conventional type is “hard wall” which is simply a metallic structure, such as steel, of sufficient thickness to prevent blade exit. Unfortunately, such metallic structure may be heavy which is contrary to the desire for lightweight aircraft structures. Another conventional type is “soft wall” which uses a structure including ballistic fabrics such as aramid fibers (e.g. KEVLAR) to provide sufficient strength at low weight.

A typical soft wall containment structure is annular, i.e., is a body of revolution about the turbofan engine's centerline axis and includes an inner shell, which may be called a “fan casing”, a cellular material comprising a large array of cells defined by thin separating walls, a “back sheet”, and a layer of ballistic fabrics such as aramid fibers (e.g. KEVLAR).

The inner surface of the inner shell forms a flowpath boundary, and the tips of the rotating fan blades pass very close to the inner surface. The inner shell may incorporate an abradable material which functions to sacrificially rub away if the fan blade tips should accidentally contact the inner shell during normal engine operation.

Most typically, the cells of the cellular material would be hexagonal and so this material is often referred to as “honeycomb”. A typical material for the cell walls is aluminum sheet which is formed in the appropriate shape and adhesively bonded or brazed together. The purpose of the honeycomb is to serve as a lightweight energy absorbing pocket and is bonded to the inner shell, for example with an adhesive.

In the prior art, the back sheet would be a material such as a polymer matrix composite (“PMC”). A typical composite system would be carbon fibers in an epoxy matrix. The purpose of the back sheet is to form a secondary structure to the honeycomb and is bonded thereto, for example with an adhesive. The layer of ballistic fabric typically includes multiple wraps of the ballistic fabrics. Different numbers of layers, weaving patterns, etc. are known.

In operation, it is understood that it is likely that the inner shell, honeycomb, and/or back sheet will be partially damaged or destroyed during a blade-out event, with the ballistic fabric forming the final backstop.

The problem with the prior art is that the PMC composite back sheet is a brittle material with relatively small elongation to ultimate failure. This may result in a large hole and/or circumferential cracking between the forward and aft cylindrical flanges and the tapered/beveled sections. Because the PMC material is brittle, this crack can easily propagate 360°, compromising the structural integrity of the soft wall containment structure.

### BRIEF DESCRIPTION OF THE INVENTION

At least one of the above-noted problems is addressed by a soft wall containment structure having a ductile, metallic back sheet.

According to one aspect of the technology described herein, a blade containment structure surrounding a fan in a turbofan engine includes a cellular material to absorb energy and contain fragments of a blade thrown outward by damage to the fan; an inner shell; a ductile back sheet spaced radially outward from the inner shell, the ductile back sheet and inner shell cooperating to define a nesting area for the cellular material, wherein the cellular material is bound at its radially inner surface by the inner shell and at its outer surface by the ductile back sheet; and a containment blanket overlaid on the ductile back sheet, the containment blanket being of the type effective to contain fragments of the blade that penetrate through the ductile back sheet.

According to another aspect of the technology described herein, in a gas turbine engine including a fan having a plurality of blades, a fan casing, and an inlet cowl, a fan blade containment structure includes a cellular material to absorb energy and contain fragments of a blade thrown outward by damage to the fan; an inner shell; a ductile back sheet spaced radially outward from the inner shell, the ductile back sheet and inner shell cooperating to define a nesting area for the cellular material, wherein the cellular material is bound at its radially inner surface by the inner shell and at its outer surface by the ductile back sheet; and a containment blanket overlaid on the ductile back sheet, the containment blanket being of the type effective to contain fragments of the blade that penetrate through the ductile back sheet.

### BRIEF DESCRIPTION OF THE DRAWINGS

The invention may be best understood by reference to the following description taken in conjunction with the accompanying drawing figures in which:

FIG. 1 is a side view, partially in cross-section of a forward portion of a turbofan engine including a fan sealing area with a blade containment structure according to one embodiment of the invention;

FIG. 2 is an enlarged cross-sectional view of FIG. 1 illustrating in more detail the blade containment structure of FIG. 1;

FIG. 3 is a cross-sectional view of a back sheet of the blade containment structure of FIG. 2; and

FIGS. 4-8 illustrate joint configurations for assembling the blade containment structure of FIG. 2 around the turbofan engine of FIG. 1.

### DETAILED DESCRIPTION OF THE INVENTION

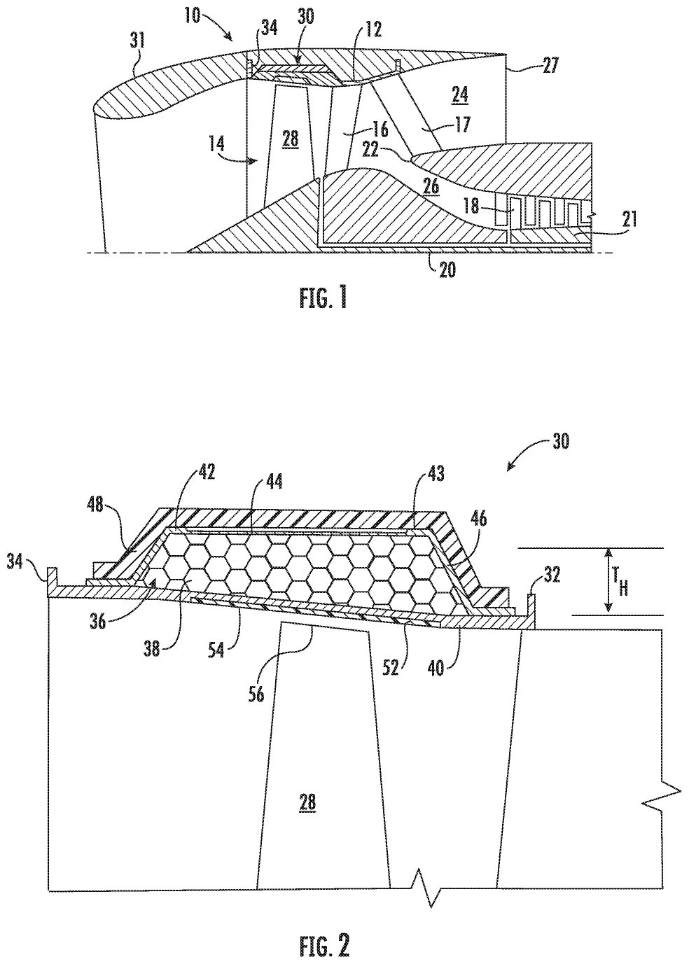

Referring to the drawings wherein identical reference numerals denote the same elements throughout the various views, FIG. 1 depicts generally at 10, an exemplary turbofan engine having a fan casing 12 which surrounds a fan 14 and is typically supported by exit guide vanes 16 and struts 17. A compressor section 18 is located aft of the fan 14. Other conventional elements such as a combustion section, a turbine section and exhaust section (not shown) are included in a conventional engine. Since these are conventional elements well known to those skilled in the art, further illustration and description thereof is omitted.

Shafts 20, 21 driven by turbines (not shown) drive compressor section 18 as well as fan 14 at a high speed. Fan 14 moves a large volume of air through exit guide vanes 16 where it is divided by a splitter 22 into a bypass flowpath 24 and an engine flowpath 26. The relatively large volume of air which flows in bypass flowpath 24 is delivered directly to an annular fan discharge nozzle 27 where it produces a substantial amount of the total thrust of turbofan engine 10. The remaining air flow through engine flowpath 26 is compressed, heated, and employed to drive turbines (not shown) which drive compressor section 18 and fan 14 as well as providing an exhaust which produces the remainder of the thrust from turbofan engine 10.

The fan 14 includes a plurality of circumferentially spaced fan blades 28 which may be made of a high-strength, low weight material such as a titanium alloy or composite. Each such blade may weigh on the order of 2 to 3 pounds and, when rotating at its designed speed, may have a kinetic energy of about 30,000 foot pounds. An annular blade containment structure 30 according to one embodiment of the present invention is disposed immediately surrounding the path of blades 28 and is effective for receiving blade fragments which may be accidentally released and retaining them without permitting them to become free projectiles exterior to turbofan engine 10. Furthermore, the blade containment structure 30 is also effective for supporting an inlet cowl 31.

Referring now to FIG. 2, blade containment structure 30 is attached to the turbofan engine 10 at an aft flange 32 of an aft portion of the fan casing 12 and is effective for supporting forward portions of the turbofan engine 10, such as the inlet cowl 31, at a forward flange 34.

The blade containment structure 30 includes a nesting area 36 for receiving a cellular material 38 therein. As illustrated, the cellular material 38 is formed in a honeycomb configuration but may be of any configuration and material suitable for absorbing energy. For example, the cellular material 38 may be formed of aluminum.

Cellular material 38 is bounded at its radially inner surface by inner shell 40 and at its outer surface by back sheet 46. A containment blanket 48 which may include, for example, a plurality of plies or layers of ballistic fabric such as KEVLAR is overlaid on back sheet 46. Containment blanket 48 is secured in position by any suitable means such as, for example, by clamping the edges thereof by conventional means (not shown).

A shallow depression 52 in inner shell 40 contains a suitable rub strip 54 against which tips 56 of the blades 28 are closely fitted for providing a sealing area for reducing the amount of air leaking over the tips 56. Rub strip 54 is a material which may be easily and smoothly worn away by tip 56 of blade 28 during initial run in so that as tight a tip seal as possible is obtained. Since this material and the technique for its use is conventional, it will not be further detailed herein.

Referring to FIG. 3, the back sheet 46 may be contoured or tapered. As illustrated, the back sheet 46 has a full thickness “T” of material located at the forward and aft ends 42, 43 and a tapered or thinner middle zone 44 with a lower thickness “t” which would correspond to the axial location of the rotating fan blades 28. The thickness of the back sheet 46 is optimized to help retain a blade or blade fragment during a blade-out event. In other words, if the middle zone 44 is too thin, it may bulge too much during a blade-out event. If it is too thick, it might affect the performance of forward and aft rings.

The middle zone 44 may be thinner because it is located in an area where there is a maximum thickness “Tx” of the cellular material 38, FIG. 2, and is well-supported and protected, so less material thickness is required.

The back sheet 46 is formed of a ductile material, i.e., not brittle and capable of being deformed without compromising structural integrity. Examples of a ductile material include metal alloys such as aluminum and titanium. Because the back sheet 46 material is ductile, holes are less likely to form as a result of primary damage and cracks are less likely to propagate from the primary damage into the forward and aft cylindrical flanges 34, 32; thus, maintaining structural integrity.

The back sheet 46 is spaced a predetermined distance radially outward from the inner shell 40 and the blade tips 56. The predetermined distance exceeds a maximum radial penetration distance of the tips 56 of the blades 28 in a maximum unbalanced condition of the fan 14. The exact depth of the cellular material 38 required to create this spacing depends, of course, on the engine and the type of damage which it may experience. One skilled in the art, in light of the present disclosure, would be able to determine this depth for any engine of interest under a given set of circumstances.

When or if one or more fragments of blades 28 are freed, the fragments may create puncture holes in inner shell 40 and extend into the cellular material 38 which is designed to crush and contain the fragments. However, in a severe blade-out, fragments may extend past the cellular material 38 and into the back sheet 46. Due to the back sheet being made of a ductile material, the back sheet 46 can bend or deform in an effort to contain the fragments prior to the fragments reaching the containment blanket 48.

Hypothetically, the blade containment structure 30 may be a complete 360-degree annulus. However, due to radial stack-up of components which are rigid and do not have radial clearance, this could be difficult to assemble. For example, inserting the cellular material 38 axially into the back sheet 46 could be difficult due to the shape of the cellular material 38 and shape of the back sheet 46.

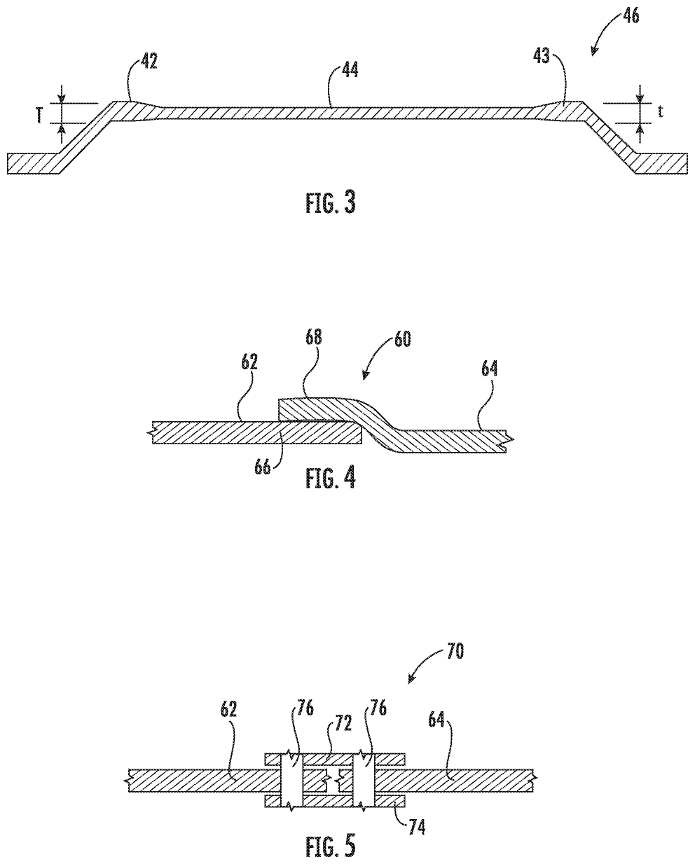

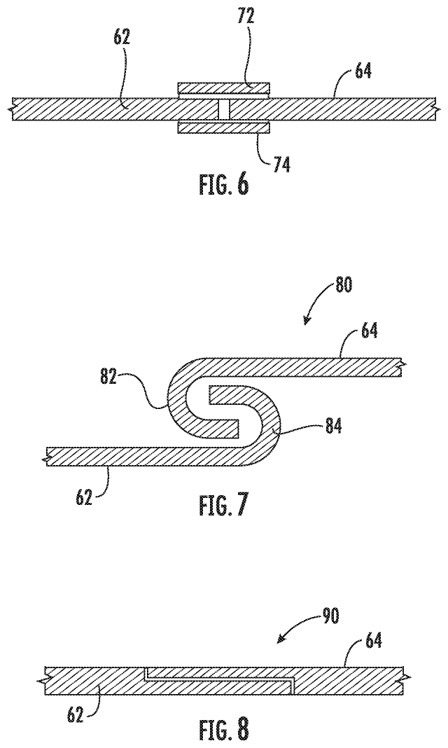

The back sheet 46 could be made of two or more segments which are assembled into a 360-degree ring. Joints between the segments would need to be rigid and have adequate strength. As illustrated in FIGS. 4-8, there are several possible configurations for joints between segments. For example, FIG. 4, an offset lap joint 60 may be used to interconnect the segments 62 and 64. The offset lap joint 60 may be assembled with an adhesive or by welding the ends 66, 68 together. A butt joint 70 provided with splice plates 72, 74, FIG. 5, may be used and may be assembled with rivets or other fasteners 76. Alternatively, FIG. 6, the splice plates 72, 74 may be assembled using an adhesive or by welding the splice plates 72, 74 to opposing sides of the segments 62 and 64. An interlocking lap joint 80, FIG. 7, uses a pair of opposing hooks 82, 84 and may be secured using an adhesive or by welding. Lastly, FIG. 8, joint 90 is a flush lap joint (“shiplap”) which may be assembled using an adhesive or by welding the segments 62, 64 together.

The blade containment structure 30 provides the benefit of a soft wall containment structure with the added benefit of a ductile back sheet 46 to contain blade fragments that extend beyond the cellular material 38. The ductile back sheet 46 helps retain the fragments by expanded and/or deforming when a fragment hits the back sheet 46 as opposed to the prior art method of using a back sheet that is not ductile and is prone to breaking.

The foregoing has described a blade containment structure. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A blade containment structure, comprising:
a cellular material to absorb energy and contain fragments of a blade thrown outward;
an inner shell;
a ductile back sheet spaced radially outward from the inner shell, the ductile back sheet and inner shell cooperating to define a nesting area for the cellular material, wherein the cellular material is bound at its radially inner surface by the inner shell and at its outer surface by the ductile back sheet; and
a containment blanket overlaid on the ductile back sheet, the containment blanket being of the type effective to contain fragments of the blade that penetrate through the ductile back sheet.

2. The blade containment structure according to claim 1, wherein the blade containment structure is formed of two or more segments.

3. The blade containment structure according to claim 2, wherein the two or more segments are joined together using joint configurations selected from the group consisting of an offset lap joint, a butt joint with splice plates, an interlocking lap joint, and a flush lap joint.

4. The blade containment structure according to claim 3, wherein the joint configurations are assembled using an adhesive.

5. The blade containment structure according to claim 3, wherein the joint configurations are assembled using a fastener.

6. The blade containment structure according to claim 3, wherein the joint configurations are assembled by welding.

7. The blade containment structure according to claim 1, wherein the cellular material is of a honeycomb configuration.

8. The blade containment structure according to claim 1, wherein the inner shell includes a rub strip disposed in a depression of the inner shell.

9. The blade containment structure according to claim 1, wherein the ductile back sheet includes:
a forward end having a first thickness;
an aft end having a thickness equal to the first thickness; and
a middle zone positioned between the forward end and the aft end, the middle zone having a second thickness less than the first thickness.

10. The blade containment structure according to claim 9, wherein the second thickness of the middle zone is aligned with an axial location of a rotatable blade.

11. The blade containment structure according to claim 1, wherein the containment blanket includes a plurality of plies or layers of a ballistic fabric.

12. The blade containment structure according to claim 1, wherein the ductile back sheet is formed of ductile metal alloy.

13. The blade containment structure according to claim 1, wherein the back sheet is spaced radially outward from the inner shell a predetermined distance, the predetermined distance exceeding a maximum radial penetration distance of tips of the blades of a rotor in a maximum unbalanced condition.

14. In a gas turbine engine including a fan having a plurality of blades, a fan casing, and an inlet cowl, a fan blade containment structure comprising:
a cellular material to absorb energy and contain fragments of a blade thrown outward;
an inner shell;
a ductile back sheet spaced radially outward from the inner shell, the ductile back sheet and inner shell cooperating to define a nesting area for the cellular material, wherein the cellular material is bound at its radially inner surface by the inner shell and at its outer surface by the ductile back sheet; and
a containment blanket overlaid on the ductile back sheet, the containment blanket being of the type effective to contain fragments of the blade that penetrate through the ductile back sheet.

15. The gas turbine engine according to claim 14, wherein the ductile back sheet includes:
a forward end having a first thickness;
an aft end having a thickness equal to the first thickness; and
a middle zone positioned between the forward end and the aft end, the middle zone having a second thickness less than the first thickness.

16. The gas turbine engine according to claim 15, wherein the second thickness of the middle zone is aligned with an axial location of a rotatable blade of the fan.

17. The gas turbine engine according to claim 14, wherein the blade containment structure is formed of two or more segments.

18. The gas turbine engine according to claim 14, wherein the two or more segments are joined together using joint configurations selected from the group consisting of an offset lap joint, a butt joint with splice plates, an interlocking lap joint, and a flush lap joint.

19. The gas turbine engine according to claim 14, wherein the ductile back sheet is formed of ductile metal alloy.

20. The gas turbine engine according to claim 14, wherein the containment blanket includes a plurality of plies or layers of a ballistic fabric.
